(19) United States
(12) Patent Application Publication
(10) Pub. No.: US 2019/0193904 A1
(43) Pub. Date: Jun. 27, 2019

(54) POLYPROPYLENE BASED SEALANT FILM FOR RETORT PACKAGING, AND LAMINATE THAT USES THE SAME

(71) Applicant: TORAY ADVANCED FILM CO., LTD, Tokyo (JP)

(72) Inventors: Ryo Toyoshima, Takatsuji-shi (JP); Youichi Matsuura, Takatsuki-shi (JP); Yoshitaka Fukagai, Takasuki-shi (JP)

(21) Appl. No.: 15/755,661

(22) PCT Filed: Aug. 2, 2016
(86) PCT No.: PCT/JP2016/072637

§ 371 Date: Feb. 27, 2018

(30) Foreign Application Priority Data
Aug. 31, 2015 (JP) 2015-170147

(51) Int. Cl. B65D 65/40; B32B 7/12; B32B 15/088; B32B 15/085; B32B 15/20; B32B 27/08; B32B 27/16; B32B 27/32; B32B 27/34; B32B 27/36; C08L 53/00; C08J 5/18

(52) U.S. Cl. CPC B65D 65/40; C08J 2423/06; B32B 15/088; B32B 15/085; B32B 15/20; B32B 27/08; B32B 27/16; B32B 27/32; B32B 27/34; B32B 27/36; C08L 53/00; C08J 5/18; B32B 2307/558; B32B 2307/734; B32B 2307/31; B32B 2439/46; B32B 2439/70; B32B 2553/00; C08L 2203/162; C08J 2353/00; B32B 7/12

(57) ABSTRACT

A polypropylene based sealant film for retort packaging includes a film made of a resin composition that contains 70 to 85 wt % of a propylene/ethylene block copolymer (a) and 15 to 30 wt % of a low-density polyethylene based polymer (b), wherein, as for the propylene/ethylene block copolymer (a), a proportion of a 20° C. xylene insoluble portion is 75 to 85 wt % relative to 100 wt % of (a), a limiting viscosity ([η]_{H}) of the insoluble portion is 1.7 to 2.0 dl/g, and a limiting viscosity ([η]_{EP}) of a soluble portion is 3.0 to 3.4 dl/g, and the low-density polyethylene based polymer (b) has a density of 0.900 to 0.930 g/cm³ and a melt flow rate of 1 to 10 g/10 minutes.

### TECHNICAL FIELD

This disclosure relates to a polypropylene based sealant film for retort packaging and a laminate that uses the same. More specifically, the disclosure relates to a polypropylene based sealant film for retort packaging and a laminate thereof that are particularly excellent in low-temperature impact resistance and orange-peel formation resistance and also excellent in seal strength, blocking resistance, and bend whitening resistance and widely usable as large-size retort packaging bags for high-retort uses.

### BACKGROUND

As sealant films for retort packaging that are retort sterilized at high temperatures of 120° C. to 135° C., a non-stretched film containing a propylene/ethylene block copolymer as a main component (hereinafter, sometimes referred to as CPP) has been used. In a major method of use thereof, CPP is pasted together with a stretched polyethylene terephthalate (hereinafter, sometimes referred to as PET) film, a stretched nylon film (hereinafter, sometimes referred to as ON), and an aluminum foil (hereinafter, sometimes referred to as Al foil) to form a laminate that has a configuration of PET film/ON/Al foil/CPP, PET film/Al foil/ON/CPP, or PET film/Al foil/CPP, which is then formed into bags and used.

CPP, which forms the innermost surface, is required to have properties such as low-temperature impact resistance, heat seal property, orange-peel formation resistance, blocking resistance and the like. Particularly in recent years, the size of pouches for industrial use or the like has become larger and the required levels of low-temperature impact resistance and the like have become even higher. The required quality level of external appearance of pouches also has become higher and it is desired that occurrence of an external appearance with small protuberances and depressions, so-called orange peel produced on a laminate surface after retort sterilization, be minimized.

Various resins as being suitable for the CPP for use in films for retort packaging have been proposed.

Japanese Unexamined Patent Publication (Kokai) No. HEI 06-93062 discloses that, to achieve both a low-temperature impact resistance and a blocking resistance, a polymer portion (A component) made up mainly of propylene and an ethylene/propylene copolymer portion (B component) are polymerized by a gas phase method, with the ratio between the limiting viscosities of A component and B component being restricted to or below a certain value and the low molecular weight proportion of a xylene soluble portion being kept low. However, while the low-temperature impact resistance achieved is basically excellent, the drop-bag strength depends greatly on the bag production condition, which is unsatisfactory. To solve this problem, Japanese Unexamined Patent Publication (Kokai) No. HEI 10-87744 discloses that the foregoing A component be a propylene/ethylene copolymer whose ethylene content is 0.5 to 1.5 wt %.

However, in a film using such a propylene/ethylene block copolymer, if the xylene soluble amount is increased to increase the low-temperature impact resistance, blocking becomes likely to occur and, after the film is formed into bags, problem occurs with the ease of opening the bags at the time of filling with contents. To solve such a problem, a proposal that a small amount of high-density polyethylene be compounded into a propylene/ethylene block copolymer whose xylene soluble amount is specified is made in Japanese Unexamined Patent Publication (Kokai) No. HEI 10-158463. However, that sometimes results in degradation of the low-temperature impact resistance.

Furthermore, Japanese Unexamined Patent Publication (Kokai) No. 2000-186159 proposes that, to obtain a film good in blocking resistance and heat seal property, the component amount of the ethylene/propylene copolymer portion be increased and the limiting viscosity thereof be increased, the limiting viscosity and the xylene soluble amount of the film being specified. However, when such a film is used, the low-temperature impact property and the blocking resistance become good but there is a problem that the orange peel proofness is not good particularly when a bag made of the film contains oily food, perhaps because the ethylene/propylene copolymer part, which is a rubber component, forms relatively large islands.

On another hand, Japanese Unexamined Patent Publication (Kokai) No. 2000-256532, to provide a film good in such orange peel, discloses that an ethylene based copolymer elastomer is compounded into a specific propylene/α-olefin block copolymer, and Japanese Unexamined Patent Publication (Kokai) No. 2000-119480 discloses a film that, for the purpose of improving bend whitening resistance, uses a propylene/ethylene block copolymer whose relation between the limiting viscosities of the paraxylene soluble and insoluble portions is prescribed and an ethylene/α-olefin copolymer that has a specific limiting viscosity. However, the single-layer film described in JP '532 does not achieve a sufficient improvement effect and has a problem of resulting in a reduced heat seal strength when used to form a two-layer laminate film made up also of a propylene/α-olefin block copolymer whose xylene soluble portion is different in intrinsic viscosity, an ethylene based copolymer elastomer, and a linear polyethylene resin. Particularly, the film described in JP '480 is not sufficient in the heat seal strength after retorting.

On another hand, to provide a sealant film good in content visibility, concretely, the transparency represented by haze and the visually inspected see-through property, and excellent in bending whitening, a polypropylene based film made up of four components that are a specific propylene/ethylene block copolymer (a), an ethylene based polymer (b) having a specific density, an ethylene/α-olefin random copolymer (c) having a specific density, and two or more kinds of propylene based polymers (d) different in molecular weight has been proposed (International Publication WO 2006/057378), and it has been proposed that the film will make a film that has a low-temperature impact resistance, a heat seal property, and a blocking resistance and that is good in transparency and see-through property and excellent in bending whitening as well. However, for size increase of pouches, the heat seal strength and the low-temperature impact property of the film need to be further increased.

Furthermore, to satisfy requirements in low-temperature impact resistance, heat seal property, bend whitening resistance, orange-peel formation resistance, blocking resistance and the like, at high levels, it has been proposed that the amount of a rubber component and the molecular weight thereof in a propylene/ethylene block copolymer that makes up a main portion of a film be adjusted and the film be made up of an ethylene/α-olefin copolymer and a polyethylene based polymer (Japanese Unexamined Patent Publication (Kokai) No. 2012-172124), which provides a sealant film and a laminate that are very excellently balanced. However, in recent years, even a higher level of low-temperature impact resistance is sometimes required, which sometimes cannot be satisfied by this film. Further, it has been proposed that the amount of a rubber component and the molecular weight thereof in a propylene/ethylene block copolymer that makes up a main portion of a film be adjusted and the film be made up of an ethylene/α-olefin copolymer, a polyethylene based polymer, and a styrene based block copolymer or a crystalline olefin block (Japanese Unexamined Patent Publication (Kokai) No. 2013-87275). However, that does not necessarily achieve a satisfactory impact resistance.

As stated above, increasingly higher levels of qualities of retort packaging sealants have been demanded in recent years to cope with the increasing sizes of industrial-use pouches, and the films with configurations that have been disclosed so far are still insufficient in low-temperature impact resistance and a film that satisfies all requirements in orange-peel formation resistance, blocking resistance, heat seal strength and the like at high levels in good balance has not been found.

It could therefore be helpful to provide a polypropylene based sealant film for retort packaging and a laminate using the film that are widely usable in high retort uses as large-size retort packaging bags, are excellent in low-temperature impact resistance and also excellent in orange-peel formation resistance, seal strength, blocking resistance, bend whitening resistance and the like.

### SUMMARY

We thus provide:

A polypropylene based sealant film for retort packaging that is a film made up of at least a resin composition that contains 70 to 85 wt % of a propylene/ethylene block copolymer (a) and 15 to 30 wt % of a low-density polyethylene based polymer (b), wherein, as for the propylene/ethylene copolymer (a), a proportion of a 20° C. xylene insoluble portion is 75 to 85 wt % relative to 100 wt % of (a), a limiting viscosity ([η]_{H}) of the insoluble portion is 1.7 to 2.0 dl/g, and a limiting viscosity ([η]_{EP}) of a soluble portion is 3.0 to 3.4 dl/g, and wherein the low-density polyethylene based polymer (b) has a density of 0.900 to 0.930 g/cm³ and a melt flow rate of 1 to 10 g/10 minutes.

The polypropylene based sealant film for retort packaging in which the low-density polyethylene based polymer (b) is a linear low-density polyethylene.

A laminate in which the foregoing sealant film is laminated on one side surface of a substrate layer in which one layer or two or more layers of films are laminated.

The polypropylene based sealant film for retort packaging has a low-temperature impact resistance and an orange-peel formation resistance at very high levels and are also excellent in seal strength, blocking resistance, and bend whitening resistance and can be used as a sealant film suitable for retort packaging. Furthermore, the laminate can provide packaging bags for retort that are very excellent in drop-bag strength and capable of suitably coping with the increasing sizes of pouches for industrial uses and the like and that do not easily form an orange peel or the like when used to package oily food and that are good in external appearance and excellent in seal strength and the like.

### DETAILED DESCRIPTION

The polypropylene based sealant film for retort packaging and the laminate that uses the film will be described below.

A polypropylene based sealant film for retort packaging is a film made up of a resin composition that contains a 70 to 85 wt % of a propylene/ethylene block copolymer (a) and 15 to 30 wt % of a low-density polyethylene based polymer (b).

As for the propylene/ethylene block copolymer (a), it is necessary that a proportion of a 20° C. xylene insoluble portion be 75 to 85 wt % relative to 100 wt % of (a), a limiting viscosity (hereinafter, sometimes referred to as [η]_{H}) of the insoluble portion be 1.7 to 2.0 dl/g, and a limiting viscosity (hereinafter, sometimes referred to as [η]_{EP}) of a soluble portion be 3.0 to 3.4 dl/g. The 20° C. xylene insoluble portion and the soluble portion mentioned above refer to as follows. After pellets of the propylene/ethylene block copolymer are completely dissolved in boiling xylene, the solution is cooled to 20° C. and left to stand for 4 or more hours. After that, this is separated into a deposit and a solution by filtration. The deposit is referred to as 20° C. xylene insoluble portion and a portion obtained by exsiccating the solution portion (filtrate) and then drying it under a reduced pressure at 70° C. is referred to as soluble portion.

This xylene insoluble portion corresponds to a sea component made up of polypropylene in the propylene/ethylene block copolymer and the xylene soluble portion corresponds to an island component made up of an ethylene/propylene copolymerization rubber component. As for the proportions of the insoluble portion and the soluble portion, the proportion of the insoluble portion needs to be 75 to 85 wt %. If the insoluble portion is less than 75 wt %, the increased proportion of the soluble portion reduces the blocking resistance, the heat resistance, the rigidity, and the heat seal strength. If the insoluble portion is more than 85 wt %, the low-temperature impact resistance contributed to by the soluble portion becomes insufficient.

Furthermore, the limiting viscosity ([η]_{H}) of the xylene insoluble portion is 1.7 to 2.0 dl/g. If the limiting viscosity ([η]_{H}) is less than 1.7 dl/g, the molecular weight of the polypropylene as a sea component is small so that the low-temperature impact resistance and the bend whitening resistance become insufficient. If the limiting viscosity ([η]_{H}) is greater than 2.0 dl/g, the molecular weight of polypropylene becomes excessively great, making cast molding difficult.

Furthermore, the limiting viscosity ([η]_{EP}) of the xylene soluble portion is 3.0 to 3.4 dl/g. Adding the low-density polyethylene based polymer (b) to the propylene/ethylene block copolymer (a) can disperse an increased amount of the island component made up of the polyethylene based polymer component so that the orange-peel formation resistance and the low-temperature impact resistance can be improved. However, if the limiting viscosity ([η]_{EP}) is not greater than or equal to 3.0 dl/g, the seal strength conspicuously decreases. Furthermore, if the limiting viscosity ([η]_{EP}) is greater than 3.4 dl/g, the orange peel phenomenon occurs. Incidentally, it is preferable that the ethylene content of the xylene soluble portion be 20 to 50 wt %. If the content rate is less than 20 wt %, the low-temperature impact resistance at low temperatures decreases. Conversely, if the content rate is greater than 50 wt %, the blocking resistance tends to be insufficient.

Adding the foregoing low-density polyethylene based polymer (b) to the propylene/ethylene block copolymer (a) and increasing the component that is lower in glass transition point than polypropylene will improve the low-temperature impact resistance, and finely dispersing a greater amount of the polyethylene component uniformly in the polypropylene will improve the orange-peel formation resistance.

The low-density polyethylene based polymer (b) needs to be contained in an amount of 15 to 30 wt % as a composition proportion in the polypropylene based sealant film for retort packaging. If the polyethylene based polymer is less than 15 wt %, it sometimes happens that the effect that improves the low-temperature impact resistance, the orange-peel formation resistance, and the bend whitening resistance is not sufficient; on the other hand, if it exceeds 30 wt %, the seal strength and the blocking resistance decrease and the workability and the ease of opening of bags deteriorate.

Furthermore, the melt flow rate (hereinafter, sometimes referred to as MFR, whose unit is g/10 minutes) of the propylene/ethylene block copolymer (a) is preferably, for example, 0.5 to 5 g/10 minutes and more preferably 1 to 3.5 g/10 minutes, from the viewpoint of cast moldability and the viewpoint of decreases in the low-temperature impact resistance and concern for occurrence of gel or fisheye. If the MFR is less than 0.5, it sometimes happens that the melt viscosity is excessively high so that stable extrusion from a die at the time of film formation is difficult. If the MFR exceeds 5, the low-temperature impact resistance sometimes deteriorates.

As adjustment methods for the melt flow rate and the limiting viscosity of the xylene insoluble and soluble portions of the propylene/ethylene block copolymer (a), a method in which a molecular weight adjusting agent such as hydrogen gas or a metal compound, in steps during the polymerization of the propylene/ethylene block copolymer (a), a method in which when a polymer obtained in a powder state is melt-kneaded and pelletized, an additive is added, a method in which when a polymer obtained as a powder is melt-kneaded and pelletized, the kneading condition is adjusted, etc. can be cited.

As a manufacturing method for the propylene/ethylene block copolymer (a), a method in which propylene, ethylene and the like, which are raw materials, are polymerized by using catalysts, can be cited. As the catalyst, Ziegler-Natta catalyst type or metallocene catalysts, and the like, can be used. For example, catalysts that can be cited in Japanese Unexamined Patent Publication (Kokai) No. HEI 07-216017 can be suitably used.

Concretely, (1) a trivalent titanous compound-containing solid catalyst obtained by reducing a titanium compound represented by a general formula Ti(OR)ₐX₄₋ₐ (where R is represents a hydrocarbon group whose carbon number is 1 to 20, X represents a halogen atom, and a represents a numeral satisfying 0<a≤4, preferably 2≤a≤4, more preferably a=4) by an organic magnesium compound in the presence of an organic silicon compound that contains an Si—O bond and an ester compound, treating the obtained solid product with an ester compound, and then treating the obtained product with a mixture of an ether compound and titanium tetrachloride or a mixture of an ether compound, titanium tetrachloride, and an ester compound,

(2) an organic aluminum compound, and
(3) a catalyst family made up of an electron-donating compound (dialkyl dimethoxysilane or the like is preferably used) can be cited.

As for the manufacturing method for the propylene/ethylene block copolymer (a), from the view point of productivity and low-temperature impact resistance, it is preferable to use a method in which, in a first step, a polymer portion mainly made up of propylene is polymerized substantially in the absence of inert solvent and then, in a second step, ethylene/propylene copolymer is polymerized in a gas phase.

The polymer portion made up mainly of propylene, from the viewpoint of heat resistance, rigidity and the like, is preferably a propylene homopolymer whose melting point is higher than or equal to 160° C.; however, the polymer portion may also be a copolymer of propylene and a small amount of α-olefin such as ethylene or 1-butene, as long as its melting point is higher than or equal to 160° C.

Next, it is preferable that the density of the low-density polyethylene based polymer (b) be 0.900 to 0.930 g/cm³. The polyethylene based polymer is ethylene alone or a copolymer of ethylene and α-olefin whose carbon number is greater than or equal to 3, for example, propylene, 1-butene, 1-pentene, 4-methylpentene-1, 1-hexene, 1-octene and the like. A polyethylene based polymer produced by a generally known method can be used. Concretely, high-pressure process low-density polyethylenes and linear low-density polyethylenes can be used. Especially, linear low-density polyethylenes are preferable because the linear low-density polyethylenes are higher in impact strength and higher in seal strength than high-pressure process low-density polyethylenes. It is sometimes the case that if the density thereof is higher than 0.930 g/cm³ the low-temperature impact resistance decreases and if the density of the polyethylene based polymer is less than 0.900 g/cm³ the blocking resistance decreases. Furthermore, the use of the polyethylene-based polymer produced via a metallocene-based catalyst is more preferable from the viewpoint of seal strength.

Furthermore, the melt flow rate (MFR, whose unit is g/10 minutes) at 190° C. of the low-density polyethylene based copolymer (b) is 1 to 10 g/10 minutes from the viewpoint of low-temperature impact resistance and heat seal property. Preferably, 1 to 5 g/10 minutes can be indicated as an example. If the MFR is less than 1, non-uniform flow due to melt fracture becomes likely to occur. On the other hand, if the MFR exceeds 10, the low-temperature impact resistance and the seal strength sometimes deteriorate.

The polypropylene based sealant film for retort packaging is obtained by mixing the foregoing two components (a) and (b) by an ordinary method and forming the obtained mixture into a film by an ordinary method. As the melt film formation method, there are an inflation method, a die method, a calender method and the like. In particular, the die method can be suitably adopted. For example, the film can be produced by melting and kneading a necessary amount of pellets or powder of the components (a) and (b) in a single-screw or double-screw melt extruder and then filtering the obtained kneaded material through a filter and extruding the material through a flat die (e.g., a T die) or an annular die into a film shape. As for the temperature of the molten polymer that is extruded from the melt extruder, a temperature of 200 to 300° C. is usually applicable. However, to prevent decomposition of the polymer and obtain a film with good quality, a temperature of 220 to 270° C. is preferable. In extrusion from a T die, the extruded film is brought into contact with a cooling roll whose temperature is set to a constant temperature of 20 to 65° C. to be cooled and solidified and then is wound up. In extrusion from an annular die, a bubble is formed by a method that is generally called an inflation method and then cooled and solidified and, after that, winding-up is performed.

Although the polypropylene based sealant film for retort packaging can be stretched after being cooled and solidified, it is preferable that the polypropylene based sealant film for retort packaging be preferably a non-stretched film that is substantially not subjected to stretching. A non-stretched film that is substantially not subjected to stretching is more excellent in tear strength and does not require that, at the time of heat sealing, the heat seal temperature be increased in excess, that is, can be heat sealed at a relatively low temperature, and therefore is preferable. Furthermore, the non-stretched film refers to an extrusion cast film. In an actual film formation step, because the film can sometimes be a film slightly oriented in the film's longitudinal direction or width direction, the birefringence (a difference between the longitudinal and width directional refraction indexes) indicates 0.005 or less. Furthermore, the birefringence (Δn) can be determined as Δn=R/d by measuring a retardation R(nm) of a sample through the use of a compensator method and by using the thickness d(nm) of the film of the measurement portion.

The thus-obtained polypropylene based sealant film for retort packaging has a thickness of 20 to 300 μm and, more preferably, 40 to 100 μm.

The polypropylene based sealant film for retort packaging can be used alone as a film for packaging and can also be suitably used as a sealant film for common retort food packaging bags that contain Al foil.

The polypropylene based sealant film for retort packaging may contain an antioxidant, a heat resistant stabilizing agent, a neutralization agent, an antielectrostatic agent, a hydrochloric acid absorption agent, an anti-blocking agent, a lubricant, nucleating agent and the like within a range such that the desired objects are not impaired. As for these additives, it is permissible to use only one species thereof and it is also permissible to use a combination of two or more species.

As concrete examples of the antioxidant include, as hindered phenol-based antioxidants, 2,6-di-t-butyl phenol (BHT), n-octadecyl-3-(3′,5′-di-t-butyl-4′-hydroxy phenyl)propionate (“Irganox” 1076, “Sumilizer” BP-76), tetrakis [methylene-3-(3,5-di-t-butyl-4-hydroxyphenyl)propionate]methane (“Irganox” 1010, “Sumilizer” BP-101), tris(3,5-di-t-butyl-4-hydroxy benzyl)isocyanurate (“Irganox” 3114, Mark AO-20) and the like, and, as phosphite-based (phosphorus-based) antioxidants, tris(2,4-di-t-butylphenyl)phosphite (“Irgafos” 168, Mark 2112), tetrakis(2,4-di-t-butylphenyl)-4-4′-biphenylene-diphosphonite (“Sandstab” P-EPQ), bis(2,4-di-t-butylphenyl)pentaerythritol diphosphite (“Ultranox” 626, Mark PEP-24G), distearyl pentaerythritol diphosphite (Mark PEP-8) and the like. Especially, 6-[3-(3-t-butyl-4-hydroxy-5-methyl)propoxy]-2,4,8,10-tetra-t-butyldibenz [d,f][1,3,2]-dioxaphosphepin (“Sumilizer” GP) and 2[1-2-hydroxy-3,5-di-t-pentyl phenyl]ethyl]-4,6-di-t-pentyl phenyl acrylate (“Sumilizer” GS), which have both the hindered phenol-based and phosphite-based functions, are preferable. In particular, the use of both the two is preferable because at the time of film formation it achieves an advantageous effect in inhibiting decomposition of the 20° C. xylene soluble portion and greatly contributes to favorable achievement of both low-temperature impact resistance and blocking resistance. If the decomposition of the xylene soluble portion is facilitated, the blocking resistance deteriorates.

As for the amount of the antioxidant added, although it depends on the kind of an antioxidant used, it suffices that the amount is set at 0.05 to 0.3 wt %.

Furthermore, as the neutralization agent, compounds of hydrotalcites, calcium hydroxide and the like are preferable for the purpose of reducing emitting smoke at the time of film formation.

In the polypropylene based sealant film for retort packaging, a resin component other than the propylene/ethylene block copolymer (a) and the low-density polyethylene based polymer (b) can be added within a range such that the desired objects are not frustrated. However, the styrene based elastomer, although being able to improve the low-temperature impact resistance and the orange peel proofness when added, decreases the blocking resistance and the heat seal strength. Therefore, it is preferable that the styrene based elastomer be not added.

Furthermore, the polypropylene based sealant film for retort packaging can be subjected as necessary to a surface treatment such as a corona discharge treatment in the atmosphere which is commonly carried out industrially, a corona discharge treatment in the atmosphere of nitrogen or carbonic acid gas, a plasma treatment, an ozone treatment and the like.

Furthermore, we provide a laminate that uses the above-described polypropylene based sealant film for retort packaging. The laminate is formed by laminating a polypropylene based sealant film for retort packaging (herein termed our film) on one side surface of a substrate layer in which one layer or two or more layers of transparent films and an aluminum foil are laminated. Furthermore, the laminate is a laminate in which our polypropylene based sealant film for retort packaging is laminated on one side surface of a substrate layer made up of one layer or two or more layers of transparent films. Representative configurations of these are configurations of PET film/AL foil/our film, PET film/ON/AL foil/our film, PET film/AL foil/ON/our film, and ON/our film.

As for the manufacturing method for such a laminate, an ordinary dry laminate method in which the films constituting the laminate are pasted together by using an adhesive can be suitably adopted, and, to paste our film and a substrate layer together, a method of directly extruding a polypropylene based resin to laminate them may be adopted according to need.

These laminates are used in a bag producing process for a flat bag, a standing pouch and the like, with our film serving as a seal layer on an inside surface of such a bag.

Furthermore, the lamination structure of these laminates are selected as appropriate according to required characteristics of a packaging bag, for example, the barrier performance for satisfying the quality preservation period of a food to be packaged, the size/low-temperature impact resistance that match the weight of the content, the visibility of the content and the like.

### EXAMPLES

Our films, laminates and methods will be concretely described with reference to examples below. However, the scope of this disclosure is not limited by these examples. Furthermore, the measurement values in various evaluation items were measured by the following methods.

### (1) Content Amount of 20° C. Xylene Soluble Portion

5 g of polypropylene pellet was completely dissolved in 500 ml of boiling xylene (KANTO KAGAKU CO., INC. 1st grade) and then cooled to 20° C. and left standing for 4 hours or longer. After that, this was filtered for a deposit and a solution and thus separated into a soluble portion and an insoluble portion. As for the soluble portion, the filtrate was solidified under reduced pressure and then dried at 70° C. The weight thereof was measured to determine the content amount (wt %).

### (2) Limiting Viscosity of 20° C. Xylene Insoluble and Soluble Portions

Measurement was performed in tetralin at 135° C., using samples separated by the foregoing method and using an Ubbelohde viscometer.

### (3) Melt Flow Rate (MFR)

In conformity with JIS K-7210-1999, the propylene/ethylene block copolymer and the polyethylene based polymer were subjected to the measurement at a temperature of 230° C. and a temperature of 190° C., respectively, and both with a load 21.18N.

### (4) Density

On the basis of JIS K-7112-1999, the measurement was performed by a measurement method using a density gradient tube.

### (5) Low-temperature Impact Resistance

A PET film of 12 μm thick, a stretched nylon film of 15 μm thick, an AL foil of 9 μm thick, and a polypropylene based sealant film (termed herein our film) subjected to a corona discharge treatment were pasted together with a urethane based adhesive by an ordinary dry laminate method to create a laminate having the following configuration:

Laminate configuration: PET film/adhesive/ON/adhesive/AL foil/adhesive/our film.

Using two such laminates so that our films formed the inside surfaces of a bag, a standing pouch having a produced bag size of 150 mm×285 mm was created through the use of a CA-450-10 type Heat Sealer made by FUJI IMPULSE company for a heating time of 1.4 seconds (seal temperature: about 220° C.) and a cooling time of 3.0 seconds. After this bag was filled with 1000 cm³ of a solution of salt having a concentration of 0.1%, a retorting process was performed at 135° C. for 30 minutes. After the retorting process, the bag was stored in a refrigerator at 0° C. After that, the bags were dropped one at a time from a height of 55 cm onto a flat floor surface (the number n being 20). The number of times that each bag was dropped before the bag ruptured was recorded. In this evaluation method, if the number n is 20 and the average number of times before bag rupture occurs is 35 or more times, the laminate is well usable for industrial-use large-size retort usage.

### (6) Heat Seal Strength

Two laminates identical to those used in Item (5) were heat sealed so that our films formed the inner surface of a bag, by using a flat plate heat sealer under the condition that the seal temperature was 180° C., the seal pressure was 1 kg/cm², and the seal time was 1 second. The heat-sealed sample was subjected to a 130° C.×30 minute-retorting process, followed by measurement of its heat seal strength at a tension speed of 300 mm/minute through the use of a Tensilon of ORIENTEC company. If in this established method, the seal strength is 60 N/15 mm or greater, the laminate is well usable also in usage of industrial-use large-size retorts.

### (7) Orange-Peel Formation Resistance

Two laminates identical to those used in Item (5) were heat sealed so that our films formed the inner surface of a bag, by using a flat plate heat sealer under the condition that the seal temperature was 180° C., the seal pressure was 1 kg/cm², and the seal time was 1 second. Thus, a three-sided bag (a flat bag, with a seal width of 5 mm) having a size of 160 mm×210 mm (internal dimensions) was created. This bag was filled with a commercially sold retort curry (a retort curry “Kukure Curry Spicy” made by Housefoods Kogyo company) and then subjected to a retorting process at 135° C. for 30 minutes. Immediately after this, formation of protuberances and depressions on surfaces of the laminates were visually determined. No formation thereof was evaluated as Rank 1, slight formation thereof as Rank 2, light formation thereof as Rank 3, definite formation thereof as Rank 4, and heavy formation as Rank 5. Ranks 1 and 2 in this evaluation method were determined as being good in orange-peel formation resistance.

### (8) Blocking Resistance

Samples of our film of 30 mm thick and 100 mm long subjected to a corona discharge treatment were prepared. Ranges of 30 mm×40 mm of the seal layers of samples which formed non-corona treated surfaces were superimposed on each other. The samples were then loaded at 500 g/12 cm², thermally treated in an oven at 80° C. for 24 hours, and then left standing in an atmosphere of 23° C. and a humidity of 65% for 30 minutes or longer. Subsequently, using a Tensilon of ORIENTEC company, the samples were subjected to measurement of shear detachment force at a tension speed of 300 mm/minute. In this established method, shear detachment forces of 25 N/12 cm² or less were determined as being in a range for practical use.

### (9) Bend Whitening Resistance

After samples were subjected to a retorting process at 135° C. for 30 minutes, the samples were bent 100 times by using an MIT bending tester made by Toyo Seiki Seisaku-sho, under the condition that the sample with was 10 mm, the bending angle was 135 degrees (left-right), and the load was 514 g. After that, the whitening statuses of the bent portions were visually determined (the number n being 5). No whitening was evaluated as Rank 1, slight whitening as Rank 2, light whitening as Rank 3, and definite whitening as Rank 4, and whitening with a heavily white line state bent portion was evaluated as Rank 5. Ranks 1 and 2 according to this evaluation method were determined as good in bend whitening resistance.

### Example 1

As the propylene/ethylene block copolymer (a) and the low-density polyethylene based polymer (b), the following copolymers were used.

### Propylene/Ethylene Block Copolymer (a)

A propylene/ethylene block copolymer pellet with the content amount of the 20° C. xylene insoluble portion being 80 wt %, the limiting viscosity ([η]_{H}) thereof being 1.90 dl/g, the content amount of the 20° C. xylene soluble portion being 20 wt %, the limiting viscosity ([η]_{EP}) thereof being 3.20 dl/g, the MFR at 230° C. being 2.3 g/10 minutes, and 300 ppm of “Sumilizer” GP and 750 ppm of “Sumilizer” GS being contained as antioxidants was used.

### Low-Density Polyethylene Based Polymer (b)

A linear low-density polyethylene of which the density was 0.919 g/cm³, the MFR was 2.0 g/10 minutes, and the copolymerization component was 1-hexene (hereinafter, sometimes referred to as L-LDPE) (2022L made by Prime Polymer Co., Ltd.) was used.

80 wt % of the (a) and 20 wt % of the (b) in a pellet state were mixed by a blender and supplied to an extruder, melted and kneaded, filtered through a filter, and then extruded through a T die at 250° C. and 60 m/minute. The excluded melt was brought into contact with a cooling roll at 45° C. to be cooled and solidified, and then one side surface was subjected to a corona discharge treatment so that a film having a thickness of 70 μm was obtained. The obtained film was excellent particularly in low-temperature impact resistance and orange-peel formation resistance and also excellent in seal strength, blocking resistance, and bend whitening resistance, and had sufficient performance properties for industrial-use large-size retort usage.

### Example 2

A film 70 μm thick was obtained in substantially the same manner as in Example 1, except that the mixing proportion of the (a) and (b) used in Example 1 was changed to 70 wt % of the (a) and 30 wt % of the (b). The obtained film was excellent particularly in low-temperature impact resistance and orange-peel formation resistance and also excellent in seal strength, blocking resistance, and bend whitening resistance, and had sufficient performance properties for industrial-use large-size retort usage.

### Example 3

A film 70 μm thick was obtained in substantially the same manner as in Example 1, except that the mixing proportion of the (a) and (b) used in Example 1 was changed to 85 wt % of the (a) and 15 wt % of the (b). The obtained film had a slightly poor orange peel proofness that is of a level that poses no problem, and was excellent in low-temperature impact resistance, seal strength, blocking resistance, and bend whitening resistance, and had sufficient performance properties for industrial-use large-size retort usage.

### Example 4

As the low-density polyethylene based polymer (b), a linear low-density polyethylene (SP0540 made by Prime Polymer Co., Ltd.) of which the density was 0.903 g/cm³, the MFR was 3.8 g/10 minutes, and the copolymerization component was 1-hexene was used. A film 70 μm thick was obtained in substantially the same manner as in Example 1, except that the (b) was changed. The obtained film was excellent particularly in low-temperature impact resistance and orange-peel formation resistance and also excellent in seal strength, blocking resistance, and bend whitening resistance, and had sufficient performance properties for industrial-use large-size retort usage.

### Example 5

As the low-density polyethylene based polymer (b), a low-density polyethylene of which the density was 0.920 g/cm³ and the MFR was 7.0 g/10 minutes (hereinafter, sometimes referred to as LDPE) (L705 made by Sumitomo Chemical Company, Limited) was used. A film 70 μm thick was obtained in substantially the same manner as in Example 1, except that the (b) was changed. The obtained film was excellent particularly in low-temperature impact resistance and orange-peel formation resistance and also excellent in seal strength, blocking resistance, and bend whitening resistance, and had sufficient performance properties for industrial-use large-size retort usage.

### Example 6

A propylene/ethylene block copolymer in which the proportion of the 20° C. xylene insoluble portion was 83% ([₁]_{H}: 1.92 dl/g, [₁]_{E}p: 3.25 dl/g) was prepared, and a film of 70 thick was obtained in substantially the same manner as in Example 1. The obtained film was excellent particularly in low-temperature impact resistance and orange-peel formation resistance and also excellent in seal strength, blocking resistance, and bend whitening resistance, and had sufficient performance properties for industrial-use large-size retort usage.

### Example 7

A propylene/ethylene block copolymer in which the proportion of the 20° C. xylene insoluble portion was 77% ([₁]_{H}: 1.86 dl/g, [₁]_{E}p: 3.10 dl/g) was prepared, and a film of 70 thick was obtained in substantially the same manner as in Example 1. The obtained film was excellent particularly in low-temperature impact resistance and orange-peel formation resistance and also excellent in seal strength, blocking resistance, and bend whitening resistance, and had sufficient performance properties for industrial-use large-size retort usage.

### Comparative Example 1

A film of 70 μm thick was obtained in substantially the same manner as in Example 1, except that the propylene/ethylene block copolymer (a) was changed to a propylene/ethylene block copolymer pellet with the content amount of the 20° C. xylene insoluble portion being 87 wt %, the limiting viscosity ([η]_{H}) thereof being 1.93 dl/g, the content amount of the 20° C. xylene soluble portion being 13 wt %, the limiting viscosity ([η]_{EP}) thereof being 3.15 dl/g, the MFR at 230° C. being 2.0 g/10 minutes, and 700 ppm of “Irganox” 1010 and 250 ppm of “Irgafos” 168 being contained as antioxidants. The obtained film was good in orange-peel formation resistance, blocking resistance, heat seal property, and bend whitening resistance but poor in low-temperature impact resistance.

### Comparative Example 2

A film of 70 μm thick was obtained in substantially the same manner as in Example 1, except that the propylene/ethylene block copolymer (a) was changed to a propylene/ethylene block copolymer pellet with the content amount of the 20° C. xylene insoluble portion being 80 wt %, the limiting viscosity (N_{H}) thereof being 1.90 dl/g, the content amount of the 20° C. xylene soluble portion being 20 wt %, the limiting viscosity ([η]_{EP}) thereof being 2.80 dl/g, the MFR at 230° C. being 2.5 g/10 minutes, and 700 ppm of “Irganox” 1010, 300 ppm of “Sumilizer” GP, and 750 ppm of “Sumilizer” GS being contained as antioxidants. The obtained film was good in orange-peel formation resistance and bend whitening resistance but poor in low-temperature impact resistance, blocking resistance, and heat seal property.

### Comparative Example 3

A film of 70 μm thick was obtained in substantially the same manner as in Example 1, except that the propylene/ethylene block copolymer (a) was changed to a propylene/ethylene block copolymer pellet with the content amount of the 20° C. xylene insoluble portion being 72 wt %, the limiting viscosity ([η]_{H}) thereof being 1.89 dl/g, the content amount of the 20° C. xylene soluble portion being 28 wt %, the limiting viscosity ([η]_{EP}) thereof being 3.21 dl/g, the MFR at 230° C. being 2.2 g/10 minutes, and 700 ppm of “Irganox” 1010, 300 ppm of “Sumilizer” GP, and 750 ppm of “Sumilizer” GS being contained as antioxidants. The obtained film was good in orange-peel formation resistance, low-temperature impact resistance, and bend whitening resistance but poor in blocking resistance and heat seal property.

### Comparative Example 4

A propylene/ethylene block copolymer in which the proportion of the 20° C. xylene insoluble portion was 81% ([₁]_{H}:1.95 dl/g, [η]_{EP}:3.43 dl/g) was prepared, and a film of 70 thick was obtained in substantially the same manner as in Example 1. The obtained film was excellent in low-temperature impact resistance, seal strength, blocking resistance, and bend whitening resistance but insufficient in orange-peel formation resistance.

### Comparative Example 5

A propylene/ethylene block copolymer in which the proportion of the 20° C. xylene insoluble portion was 82% ([η]_{H}:1.65 dl/g, [η]_{EP}:3.11 dl/g) was prepared, and a film of 70 thick was obtained in substantially the same manner as in Example 1. The obtained film was excellent in orange-peel formation resistance and excellent in seal strength and blocking resistance but insufficient in low-temperature impact resistance and bend whitening resistance.

### Comparative Example 6

A film 70 μm thick was obtained in substantially the same manner as in Example 1, except that the mixing proportion of the (a) and (b) used in Example 1 was changed to 65 wt % of the (a) and 35 wt % of the (b). The obtained film was good in orange-peel formation resistance, low-temperature impact resistance, and bend whitening resistance but poor in blocking resistance and heat seal property.

### Comparative Example 7

A film 70 μm thick was obtained in substantially the same manner as in Example 1, except that the mixing proportion of the (a) and (b) used in Example 1 was changed to 90 wt % of the (a) and 10 wt % of the (b). The obtained film was good in blocking resistance and heat seal property but poor in low-temperature impact resistance, orange-peel formation resistance, and bend whitening resistance.

### Comparative Example 8

As the low-density polyethylene based polymer (b), a high density polyethylene (hereinafter, sometimes referred to as HDPE) (KEIYO Polyethylene G1900 made by KEIYO POLYETHYLENE CO., LTD.) of which the density was 0.960 g/cm³ and the MFR was 16.0 g/10 minutes was used. A film of 70 μm thick was obtained in substantially the same manner as in Example 1, except that the (b) was changed. The obtained film was good in orange-peel formation resistance but poor in low-temperature impact resistance and heat seal property.

### Comparative Example 9

As the low-density polyethylene based polymer (b), a linear low-density polyethylene (GA401 made by Sumitomo Chemical Company, Limited) of which the density was 0.935 g/cm³, the MFR was 3.0 g/10 minutes, and the copolymerization component was 1-butene was used. A film of 70 μm thick was obtained in substantially the same manner as in Example 1, except that the (b) was changed. The obtained film was excellent particularly in low-temperature impact resistance and orange-peel formation resistance and excellent in seal strength, blocking resistance, and bend whitening resistance but had insufficient performance in impact resistance for industrial-use large-size retort usage.

### Comparative Example 10

As the low-density polyethylene based polymer (b), a linear low-density polyethylene (15100C made by Prime Polymer Co., Ltd.) of which the density was 0.914 g/cm³, the MFR was 11.0 g/10 minutes, and the copolymerization component was 1-hexene was used. A film of 70 μm thick was obtained in substantially the same manner as in Example 1, except that the (b) was changed. The obtained film was excellent particularly in low-temperature impact resistance and orange-peel formation resistance and excellent in blocking resistance and bend whitening resistance but low in seal strength and had insufficient performance in impact resistance for industrial-use large-size retort usage.

### Comparative Example 11

As the low-density polyethylene based polymer (b), a very-low-density polyethylene (hereinafter, sometimes referred to as VLDPE) (AFFINITY KC8852G made by The Dow Chemical Company) of which the density was 0.875 g/cm³ and the MFR was 3.0 g/10 minutes was used. A film of 70 μm thick was obtained in substantially the same manner as in Example 1, except that the (b) was changed. The obtained film was excellent in low-temperature impact resistance and bend whitening resistance but insufficient in orange-peel formation resistance, seal strength, and blocking resistance.

TABLE 1

| | Propylene/ethylene block copolymer (a) | | | | | | | |
|---|---|---|---|---|---|---|---|---|
| | | 20° C. | | | | | | |
| | | xylene | | | Low-density polyethylene-based polymer (b) | | | |
| | Compounding | insoluble | | | | | Compounding | |
| | amount | portion | [η]_{H} | [η]_{EP} | | Density | amount | MFR |
| | wt % | wt % | dl/g | dl/g | Resin | g/cm³ | wt % | g/10 min |
| Example 1 | 80 | 80 | 1.90 | 3.20 | L-LDPE | 0.919 | 20 | 2.0 |
| Example 2 | 70 | 80 | 1.90 | 3.20 | L-LDPE | 0.919 | 30 | 2.0 |
| Example 3 | 85 | 80 | 1.90 | 3.20 | L-LDPE | 0.919 | 15 | 2.0 |
| Example 4 | 80 | 80 | 1.90 | 3.20 | L-LDPE | 0.903 | 20 | 3.8 |
| Example 5 | 80 | 80 | 1.90 | 3.20 | LDPE | 0.920 | 20 | 7.0 |
| Example 6 | 80 | 83 | 1.92 | 3.25 | L-LDPE | 0.919 | 20 | 2.0 |
| Example 7 | 80 | 77 | 1.86 | 3.10 | L-LDPE | 0.919 | 20 | 2.0 |
| Comparative | 80 | 87 | 1.93 | 3.15 | L-LDPE | 0.919 | 20 | 2.0 |
| Example 1 | | | | | | | | |
| Comparative | 80 | 80 | 1.90 | 2.80 | L-LDPE | 0.919 | 20 | 2.0 |
| Example 2 | | | | | | | | |
| Comparative | 80 | 72 | 1.89 | 3.21 | L-LDPE | 0.919 | 20 | 2.0 |
| Example 3 | | | | | | | | |
| Comparative | 80 | 81 | 1.95 | 3.43 | L-LDPE | 0.919 | 20 | 2.0 |
| Example 4 | | | | | | | | |
| Comparative | 80 | 82 | 1.65 | 3.11 | L-LDPE | 0.919 | 20 | 2.0 |
| Example 5 | | | | | | | | |
| Comparative | 65 | 80 | 1.90 | 3.20 | L-LDPE | 0.919 | 35 | 2.0 |
| Example 6 | | | | | | | | |
| Comparative | 90 | 80 | 1.90 | 3.20 | L-LDPE | 0.919 | 10 | 2.0 |
| Example 7 | | | | | | | | |
| Comparative | 80 | 80 | 1.90 | 3.20 | HDPE | 0.960 | 20 | 16.0 |
| Example 8 | | | | | | | | |
| Comparative | 80 | 80 | 1.90 | 3.20 | L-LDPE | 0.935 | 20 | 3.0 |
| Example 9 | | | | | | | | |
| Comparative | 80 | 80 | 1.90 | 3.20 | L-LDPE | 0.914 | 20 | 11.0 |
| Example 10 | | | | | | | | |
| Comparative | 80 | 80 | 1.90 | 3.20 | VLDPE | 0.875 | 20 | 3.0 |
| Example 11 | | | | | | | | |

| | Film properties | | | | |
|---|---|---|---|---|---|
| | | Low- | | | |
| | Orange- | temperature | | | |
| | peel | impact | | Heat | Bend |
| | formation | resistance | Blocking | seal | whitening |
| | resistance | Number | resistance | strength | resistance |
| | Rank | of times | N/12 cm² | N/15 mm | Rank |
| Example 1 | 1 | 38 | 20 | 63 | 2 |
| Example 2 | 1 | 40 | 23 | 61 | 2 |
| Example 3 | 2 | 35 | 18 | 65 | 2 |
| Example 4 | 1 | 38 | 22 | 61 | 2 |
| Example 5 | 1 | 35 | 20 | 60 | 2 |
| Example 6 | 1 | 42 | 19 | 64 | 2 |
| Example 7 | 1 | 35 | 24 | 60 | 2 |
| Comparative | 1 | 22 | 18 | 65 | 2 |
| Example 1 | | | | | |
| Comparative | 1 | 23 | 26 | 55 | 2 |
| Example 2 | | | | | |
| Comparative | 1 | 43 | 27 | 54 | 2 |
| Example 3 | | | | | |
| Comparative | 3 | 33 | 23 | 61 | 2 |
| Example 4 | | | | | |
| Comparative | 1 | 21 | 22 | 62 | 3 |
| Example 5 | | | | | |
| Comparative | 1 | 43 | 28 | 54 | 1 |
| Example 6 | | | | | |
| Comparative | 3 | 15 | 17 | 70 | 3 |
| Example 7 | | | | | |
| Comparative | 2 | 25 | 10 | 55 | 1 |
| Example 8 | | | | | |
| Comparative | 1 | 33 | 20 | 63 | 2 |
| Example 9 | | | | | |
| Comparative | 1 | 28 | 23 | 59 | 1 |
| Example 10 | | | | | |
| Comparative | 3 | 35 | 29 | 56 | 1 |
| Example 11 | | | | | |

### INDUSTRIAL APPLICABILITY

The polypropylene based sealant film for retort packaging is excellent particularly in low-temperature impact resistance and orange-peel formation resistance, has a blocking resistance, a heat seal property, a bend whitening resistance and the like, and is usable as a suitable sealant film also for industrial-use large-size retort packaging usage.

Furthermore, since the laminate has the polypropylene based sealant film for retort packaging stacked as a heat seal layer, use of this laminate will provide a packaging bag for retort use which is excellent particularly in low-temperature impact resistance and orange-peel formation resistance.

1-3. (canceled)

4. A polypropylene based sealant film for retort packaging comprising a film made of a resin composition that contains 70 to 85 wt % of a propylene/ethylene block copolymer (a) and 15 to 30 wt % of a low-density polyethylene based polymer (b), wherein, as for the propylene/ethylene block copolymer (a), a proportion of a 20° C. xylene insoluble portion is 75 to 85 wt % relative to 100 wt % of (a), a limiting viscosity ([η]_{H}) of the insoluble portion is 1.7 to 2.0 dl/g, and a limiting viscosity ([η]_{EP}) of a soluble portion is 3.0 to 3.4 dl/g, and the low-density polyethylene based polymer (b) has a density of 0.900 to 0.930 g/cm³ and a melt flow rate of 1 to 10 g/10 minutes.

5. The polypropylene based sealant film according to claim 4, wherein the low-density polyethylene based polymer (b) is a linear low-density polyethylene.

6. A laminate in which the polypropylene based sealant film according to claim 4 is laminated on one side surface of a substrate layer in which one layer or two or more layers of films are laminated.

7. A laminate in which the polypropylene based sealant film according to claim 5 is laminated on one side surface of a substrate layer in which one layer or two or more layers of films are laminated.
